(19) United States
(12) Patent Application Publication
(10) Pub. No.: US 2023/0045464 A1
(43) Pub. Date: Feb. 9, 2023

(54) MOTOR, BLOWER, AND METHOD FOR MANUFACTURING MOTOR

(71) Applicant: NIDEC CORPORATION, Kyoto (JP)

(72) Inventors: Yuta YAMASAKI, Kyoto (JP); Hideki AOI, Kyoto (JP); Nobuaki YASUMOTO, Kyoto (JP); Kazushi ISHIKAWA, Kyoto (JP)

(21) Appl. No.: 17/878,056

(22) Filed: Aug. 1, 2022

(30) Foreign Application Priority Data
Aug. 6, 2021 (JP) 2021-130353

(51) Int. Cl. H02K 5/22; H02K 5/08; H02K 7/14; H02K 11/33; H02K 15/12

(52) U.S. Cl. CPC H02K 5/225; H02K 5/08; H02K 7/14; H02K 11/33; H02K 15/12; H02K 2203/03

(57) ABSTRACT

Provided is a motor including a shaft, a bearing housing in a tubular shape that rotatably supports the shaft with a bearing, a casing that holds an upper end part of an outer peripheral surface of the bearing housing, a stator accommodated in the casing, a rotor, a cover configured to cover an opening formed at a lower end of a tubular part of the casing, and a resin part configured to cover the stator in a space surrounded by the bearing housing, the casing, and the cover. The cover includes a base in an annular shape and a bush disposed radially inside the base and fixed to a lower end part of the outer peripheral surface of the bearing housing.

### CROSS-REFERENCE TO RELATED APPLICATIONS

The present invention claims priority under 35 U.S.C. §119 to Japanese Patent Application No. 2021-130353 filed on Aug. 6, 2021, the entire content of which is incorporated herein by reference.

### FIELD OF THE INVENTION

The present invention relates to a motor, a blower using the motor, and a method for manufacturing the motor.

### BACKGROUND

A motor provided in a conventional fan includes a casing, a stator accommodated in the casing, and a base connected to the casing. The stator is disposed in a space defined by the casing and the base. The base is provided with a chipped opening from which resin is injected to form a filled body. The filled body makes the motor to have waterproofness and dustproofness.

Unfortunately, the structure in which resin is poured from the chipped opening provided in the base may cause the resin to be less likely to flow, so that a region without filled resin may be generated to deteriorate the waterproofness and the dustproofness.

### SUMMARY

An exemplary motor of the present invention includes: a shaft that is rotatable about a center axis extending vertically; a bearing housing in a tubular shape that rotatably supports the shaft with a bearing; a casing having a tubular part extending axially about the center axis and being located radially outside the bearing housing, and a lid expanding radially inward from an upper end of the tubular part and holding an upper end of an outer peripheral surface of the bearing housing; a stator fixed to at least one of an inner peripheral surface of the tubular part of the casing and the outer peripheral surface of the bearing housing; a rotor fixed to the shaft and disposed radially outside the casing; a cover configured to cover an opening formed in a lower end of the tubular part of the casing; and a resin part configured to cover the stator in a space surrounded by the bearing housing, the casing, and the cover. The cover includes a base in an annular shape and a bush disposed radially inside the base and fixed to a lower end part of the outer peripheral surface of the bearing housing.

An exemplary blower of the present invention includes a motor, an impeller attached to the rotor, and a frame radially covering the outside of the impeller. The base is integrally formed with the frame.

An exemplary method for manufacturing a motor according to the present invention includes the steps of: attaching a bearing housing to a lid of a casing; attaching a stator to at least one of an inner peripheral surface of a tubular part of the casing and an outer peripheral surface of the bearing housing; injecting resin into a space between the casing and the bearing housing from an opening formed axially below the tubular part of the casing to cover the stator with the resin; and covering the opening of the casing with a cover. The step of covering is performed after the step of injecting.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating an example of a blower according to the present invention;

FIG. 2 is an exploded perspective view of the blower illustrated in FIG. 1;

FIG. 3 is a perspective view of a second frame;

FIG. 4 is a longitudinal sectional view of the blower illustrated in FIG. 1;

FIG. 5 is a perspective view of a casing;

FIG. 6 is a plan view of a circuit board and a stator;

FIG. 7 is a bottom view of a circuit board;

FIG. 8 is a bottom view of a stator;

FIG. 9 is an exploded perspective view of a stator and a circuit board;

FIG. 10 is an enlarged sectional view of a snap-fit part;

FIG. 11 is an enlarged sectional view of a first recess and a first snap-fit part;

FIG. 12 is an enlarged sectional view of a second recess and a second snap-fit part;

FIG. 13 is a flowchart illustrating a manufacturing process of a blower;

FIG. 14 is a sectional view of a casing with a stator and a circuit board accommodated, the casing being vertically inverted; and

FIG. 15 is a plan view illustrating a recess and a snap-fit part of a modification.

### DETAILED DESCRIPTION

Hereinafter, an exemplary embodiment of the present invention will be described in detail with reference to the drawings. The present specification shows a blower A in which a direction parallel to a center axis Cx of the blower A is an “axial direction”, a direction orthogonal to the center axis Cx of the blower A is a “radial direction”, and a direction along an arc about the center axis Cx of the blower A is a “peripheral direction”. The present specification shows the blower A in which a shape and a positional relationship of each part are described with the axial direction as a vertical direction and an upper side close to an air inlet 121 of a frame 10 with respect to an impeller 30. The term, “vertical direction”, is a name that is used simply for description, and does not limit a positional relationship and a direction of the blower A in use. Additionally, “upstream” and “downstream” respectively indicate upstream and downstream in a direction of circulation of airflow generated when the impeller 30 is rotated.

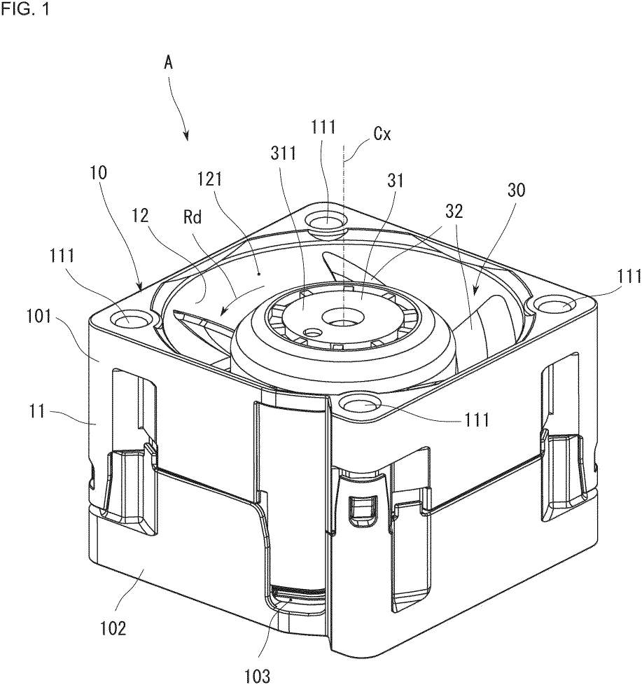

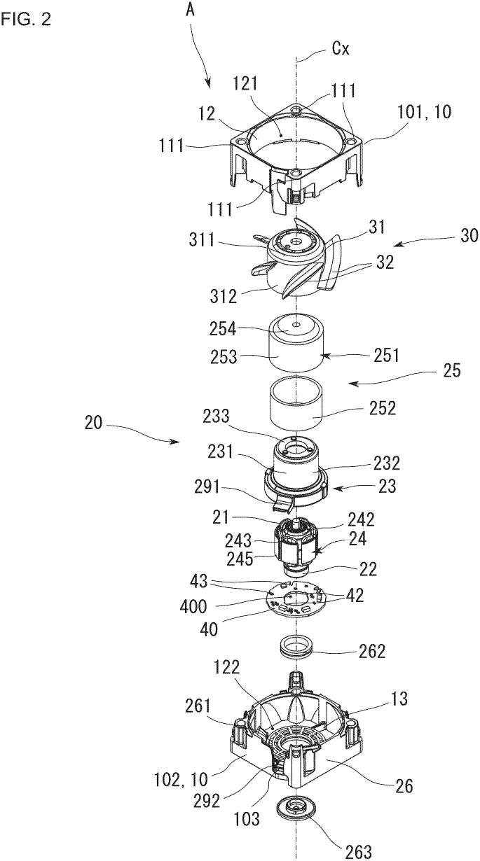

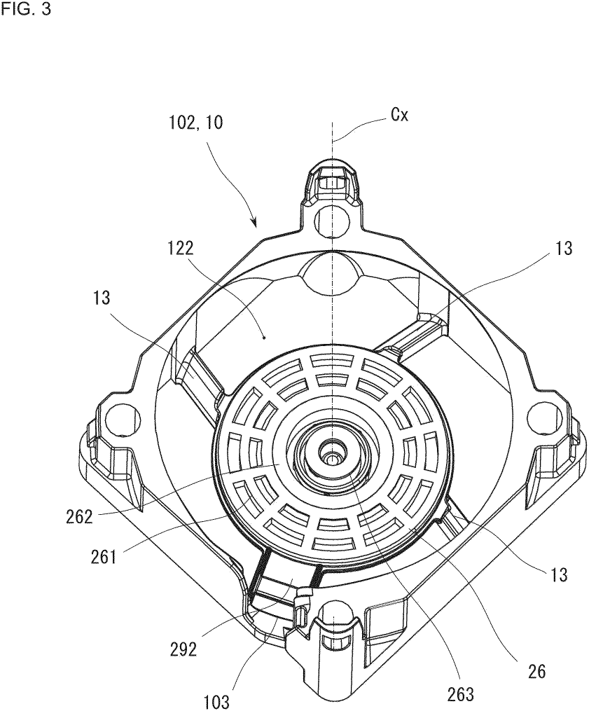

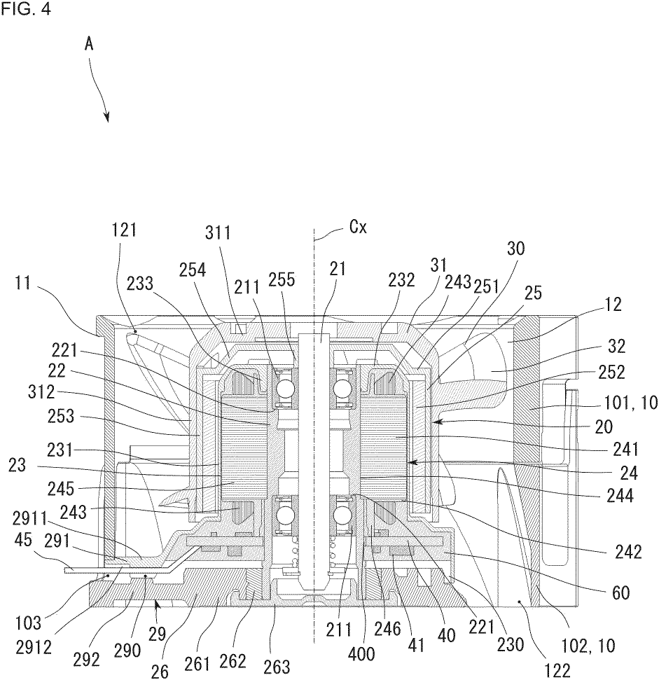

FIG. 1 is a perspective view illustrating an example of the blower A according to the present invention. FIG. 2 is an exploded perspective view of the blower A illustrated in FIG. 1. FIG. 3 is a perspective view of a second frame 102. FIG. 4 is a longitudinal sectional view of the blower A illustrated in FIG. 1.

As illustrated in FIGS. 1 to 4, the blower A according to the present embodiment includes the frame 10, a motor 20, and the impeller 30. The motor 20 is fixed to the frame 10. The motor 20 includes a rotor 25 described later that is rotatable with respect to the frame 10. The impeller 30 is attached to the rotor 25 and rotates about the center axis Cx with rotation of the rotor 25.

That is, the blower A includes the motor 20, the impeller 30 attached to the rotor 25 (described later) of the motor 20, and the frame 10 radially covering the outside of the impeller 30.

The blower A is configured such that when the impeller 30 rotates in a predetermined rotation direction Rd (see FIG. 1), air is pushed by blades 32 of the impeller 30 described later to generate airflow in an air channel 12 described later of the frame 10.

As illustrated in FIGS. 1 to 4, the frame 10 includes a frame body 11 and the air channel 12. The frame 10 in the present embodiment is formed as an integrated molding with a base 261 of a cover 26 described later of the motor 20. That is, the base 261 is a part of the motor 20 and a part of the frame 10. Details of the base 261 will be described later. That is, the base 261 is formed integrally with the frame 10.

The frame body 11 is an exterior member of the blower A. The frame body 11 is made of resin. The air channel 12 is disposed inside the frame body 11 and has an inner peripheral surface in a cylindrical shape. As illustrated in FIGS. 1 and 4, for example, the air channel 12 extends along the center axis Cx. The inner peripheral surface of the air channel 12 has a center line aligning with the center axis Cx.

The air channel 12 is a guide for guiding the airflow generated by the rotation of the impeller 30 along the center axis Cx. The air channel 12 has an upper end in the axial direction serving as the air inlet 121, and a lower end in the axial direction serving as an air outlet 122. That is, when the impeller 30 rotates, air is sucked from the air inlet 121, and airflow accelerated by the impeller 30 is discharged from the air outlet 122.

The frame body 11 has a square rectangular parallelepiped shape when viewed from the axial direction. When viewed from the axial direction, attachment holes 111 penetrating in the axial direction are formed at four corners of the square shape. For example, a screw, a boss, or the like for attachment provided in the device is inserted into each of the attachment holes 111. Then, the frame body 11 is fixed to the device by using a fixing method such as fixing a nut to a thread of the screw or caulking a boss. Although the frame body 11 has a square shape when viewed from the axial direction, it may have the shape of a circle or a polygon such as a rectangle or a hexagon. The frame body 11 may use a shape corresponding to a shape of a part of a device to which the blower A is attached, the blower A being attached to the part.

The frame 10 includes multiple stator blades 13 protruding radially inward from the inner peripheral surface of the air channel 12. The stator blades 13 each connect the air channel 12 and the base 261 of the motor 20. In other words, the base 261 is held in the air channel 12 with the stator blades 13. The stator blades 13 rectify the airflow generated by the rotation of the impeller 30.

As illustrated in FIGS. 1 and 2, for example, the frame 10 can be separated into a first frame part 101 and a second frame part 102. The first frame part 101 is disposed above the second frame part 102. That is, the frame 10 includes the first frame part 101 and the second frame part 102 that is axially coupled to a lower part of the first frame part 101. The first frame part 101 and the second frame part 102 may be separably combined using a snap-fit mechanism, but are not limited thereto. For example, a fixing tool such as a screw may be used for fixing the parts.

The frame 10 includes a lead wire placement part 103 formed by combining the first frame part 101 and the second frame part 102. The lead wire placement part 103 is configured to allow a lead wire 45 described later to be disposed therein, the lead wire 45 being connected to a circuit board 40 described later of the motor.

The blower A configured as described above can stably discharge a constant volume of air.

The motor 20 is disposed inside the frame 10. The motor 20 includes a shaft 21, a bearing housing 22, a casing 23, a stator 24, the rotor 25, the cover 26, a resin part 60, the circuit board 40, and a wiring part 29.

The shaft 21 extends along the center axis Cx. The shaft 21 has a cylindrical columnar shape, and has a center line aligning with the center axis Cx. The shaft 21 is rotatably supported in the bearing housing 22 with bearings 211 at two places separated in the axial direction. That is, the shaft 21 is rotatable about the center axis Cx extending vertically.

Here, the bearings 211 are each a ball bearing, but are not limited to thereto. Widely available examples include a type of bearing capable of rotatably supporting the shaft 21 about the center axis Cx. The shaft 21 is inserted into and fixed to an inner cylinder of each of the bearings 211. Although here the shaft 21 is fixed to the inner cylinder of each of the bearings 211 by press-fitting, the fixing is not limited thereto. The shaft 21 and the inner cylinder of each of the bearings 211 may be fixed using a fixing method such as bonding or screwing.

The shaft 21 is rotatably supported by the bearings 211 at two places separated in the axial direction. This structure enables suppressing shaft shake, shaft displacement, and the like during rotation of the shaft 21. As a result, the shaft 21 rotates stably.

The bearing housing 22 is made of metal and has a cylindrical shape extending along the center axis Cx. The bearing housing 22 has an inner peripheral surface provided with bearing holders 221 for holding the respective bearings 211. The bearing holders 221 each have a stepped shape extending from the inner peripheral surface in a direction orthogonal to the center axis Cx. When an outer ring of each of the bearings 211 is brought into contact with the corresponding one of the bearing holders 221, each of the bearings 211 can be positioned in the axial direction. The bearings 211 are fixed to the inner peripheral surface of the bearing housing 22 by press-fitting. Alternatively, the bearings 211 may be fixed by a fixing method other than the press-fitting such as screwing or bonding. The bearing housing 22 has a tubular shape and rotatably supports the shaft 21 with the bearings 211.

The stator 24 is fixed to an outer peripheral surface of the bearing housing 22. More specifically, the stator 24 includes a stator core 241 described later that is fixed to the outer peripheral surface of the bearing housing 22. The stator core 241 is fixed to the outer peripheral surface of the bearing housing 22 by press-fitting. Alternatively, a fixing method other than the press-fitting may be used for fixing the stator 24 and the bearing housing 22.

The outer peripheral surface of the bearing housing 22 has a lower end part to which the cover 26 is attached. Details of the cover 26 will be described later.

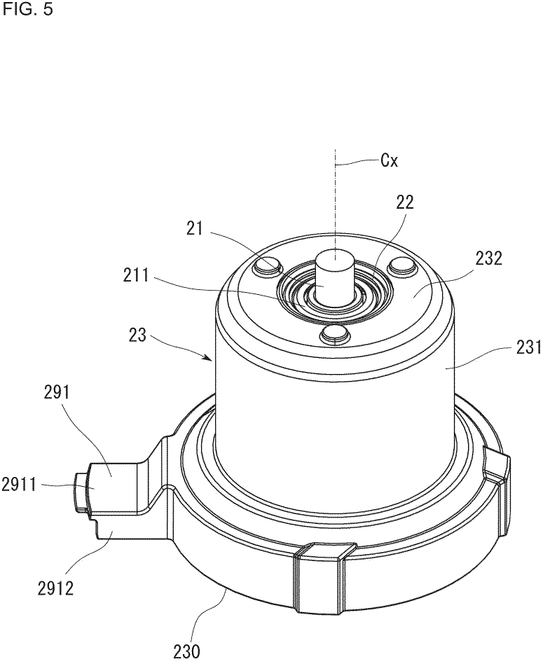

Hereinafter, the casing 23 will be described with reference to other drawings. FIG. 5 is a perspective view of the casing 23. As illustrated in FIGS. 4 and 5, for example, the casing 23 has a bottomed cylindrical shape extending in the axial direction about the center axis Cx, and holds the bearing housing 22.

The casing 23 includes a tubular part 231 and a lid part 232. As illustrated in FIG. 4, the tubular part 231 has a cylindrical shape extending along the center axis Cx. The tubular part 231 has a center line aligning with the center axis Cx. The tubular part 231 of the casing 23 is provided at its lower end with an opening 230. The opening 230 is covered with the cover 26.

The lid part 232 expands radially inward from an upper end of the tubular part 231 in the axial direction. The lid part 232 has a bearing housing attachment boss 233. The bearing housing attachment boss 233 extends axially downward from a central part of the lid part 232. The bearing housing attachment boss 233 has a tubular shape. The bearing housing attachment boss 233 has an inner peripheral surface to which an upper end part of the outer peripheral surface of the bearing housing 22 is fixed. The bearing housing 22 and the bearing housing attachment boss 233 are fixed by press-fitting. Besides this, a fixing method such as bonding or welding may be used.

The tubular part 231 of the casing 23 includes a first protrusion 291 described later of the wiring part 29. The first protrusion 291 is formed integrally with the tubular part 231. Details of the wiring part 29 and the first protrusion 291 will be described later.

The cover 26 extends in a direction orthogonal to the center axis Cx. The cover 26 includes a base 261 and a bush 262. As illustrated in FIGS. 2 and 4, the base 261 has an annular shape. The base 261 has an outer edge part that is connected to a radially inner end part of each of the stator blades 13 of the frame 10. The motor 20 of the present embodiment includes the base 261 of the cover 26 and the second frame part 102 of the frame 10 that are integrally molded with resin. That is, the base 261 is formed integrally with the second frame part 102.

The bush 262 has an annular shape and is disposed about the center of the base 261. The bush 262 is formed integrally with the base 261. That is, at least a part of the bush 262 may be integrally fixed to the base 261. This structure facilitates manufacturing of the cover 26.

In the present embodiment, the bush 262 is made of metal, and the base 261 is made of resin. Thus, the cover 26 is an insert-molded body, for example. Besides this, the bush 262 may be fixed (integrated) to the base 261 by a fixing method such as bonding or screwing. The bush 262 in the present embodiment is made of a material harder than the bearing housing 22. However, the bush 262 is not limited thereto. The lower end part of the bearing housing 22 is press-fitted into the bush 262. That is, the cover 26 includes the base 261 having an annular shape, and the bush 262 disposed radially inward of the base 261 and fixed to the lower end part of the outer peripheral surface of the bearing housing 22.

As illustrated in FIG. 4 and the like, the cover 26 includes a cap part 263 that closes an opening at the lower end part of the bearing housing 22. The cap part 263 is attached to a lower surface of the base 261 of the cover 26. The cap part 263 is in close contact with the inner peripheral surface of the bearing housing 22. Here, the term, “in close contact” is a state with no gap through which foreign materials such as water, dust, and dirt can pass. That is, the cover 26 is configured to cover the opening 230 formed at a lower end of the casing 23. As described above, the cap part 263 is in close contact with the opening at the lower end part of the bearing housing 22, so that foreign materials such as water, dust, and dirt are prevented from entering the bearing housing 22. As a result, the bearings 211 can stably operate for a long period of time.

The cover 26 includes a second protrusion 292. The second protrusion 292 protrudes radially outward from a radially outer edge of the base 261. When the cover 26 is attached to the casing 23, the second protrusion 292 is disposed axially below the first protrusion 291. Details of the second protrusion 292 will be described later.

As illustrated in FIG. 4 and the like, the stator 24 is accommodated in a space surrounded by the bearing housing 22, the casing 23, and the cover 26. The stator 24 includes the stator core 241, an insulator 242, and a coil 243.

The stator core 241 has conductivity. The stator core 241 is centered on the center axis Cx extending vertically. The stator core 241 in the present embodiment has a structure in which electromagnetic steel plates are stacked. However, the stator core 241 is not limited to this structure, and may be a single member formed by firing or casting of powder, for example. The stator core 241 includes a core back 244 in an annular shape and multiple teeth 245. The core back 244 has the annular shape extending in the axial direction. The teeth 245 protrude radially outward from an outer peripheral surface of the core back 244. The multiple teeth 245 are disposed at equal intervals in a circumferential direction.

The insulator 242 is a resin molding. The insulator 242 is configured to cover at least the teeth 245 of the stator core 241. That is, the insulator 242 is configured to cover at least a part of the stator core 241. The coil 243 is formed on each of the teeth 245 covered with the insulator 242. That is, the coil 243 is formed by winding a conductive wire around the insulator 242. The motor 20 is a DC brushless motor. Thus, three conductive wires 247 are drawn from respective different coils 243. That is, the stator 24 includes the coils 243 and the conductive wires 247 drawn out from the respective coils 243.

The insulator 242 insulates the stator core 241 from each of the coils 243. The insulator 242 is a resin molding in the present embodiment, but is not limited thereto. Any structure that can insulate the stator core 241 from each of the coils 243 can be widely adopted.

The insulator 242 has an insulator tubular part 246 extending axially downward. The insulator tubular part 246 has a lower end in contact with an upper surface of the circuit board 40.

The stator core 241 in the present embodiment has an inner peripheral surface fixed to the outer peripheral surface of the bearing housing 22 by press-fitting. As a result, the stator 24 is fixed to the bearing housing 22. The fixing of the stator 24 to the bearing housing 22 is not limited to press-fitting, and a fixing method such as welding or bonding may be used. The stator 24 in the present embodiment is fixed to the bearing housing 22. Besides this, an outer peripheral surface of the stator 24 may be fixed to an inner peripheral surface of the tubular part 231 of the casing 23. The stator 24 may be also fixed to both the bearing housing 22 and the casing 23. That is, the stator 24 is disposed inside the casing 23 and fixed to at least one of the casing 23 and the bearing housing 22.

The rotor 25 is disposed radially outward of the stator 24. The rotor 25 is fixed to the shaft 21. That is, the rotor 25 is fixed to the shaft 21 and disposed radially outward of the casing 23. The rotor 25 includes a rotor cover 251 and a magnet 252. The rotor cover 251 has the shape of a lidded tube.

The rotor cover 251 includes a rotor tubular part 253, a rotor top plate part 254, and a shaft fixing boss 255. The rotor tubular part 253 has an annular shape extending in the axial direction. The rotor tubular part 253 is disposed radially outward of the casing 23.

The rotor top plate part 254 expands radially inward from an axially upper end of the rotor tubular part 253. The shaft fixing boss 255 is disposed at a central part of the rotor top plate part 254 when viewed from the axial direction. The shaft fixing boss 255 and the rotor top plate part 254 are integrally molded. The shaft fixing boss 255 has a cylindrical shape with a through-hole in the axial direction. The shaft 21 passes through the shaft fixing boss 255, and an outer peripheral surface of the shaft 21 is fixed to an inner peripheral surface of the shaft fixing boss 255. As a result, the rotor cover 251 of the rotor 25 is fixed to the shaft 21.

As illustrated in FIGS. 2 and 4, for example, the magnet 252 has a cylindrical shape. The magnet 252 has a tubular shape in which N poles and S poles are alternately disposed in the circumferential direction. The magnet 252 has an outer peripheral surface fixed to an inner peripheral surface of the rotor tubular part 253.

The magnet 252 in the present embodiment is an integrated molding made of resin containing magnetic powder. Besides this, multiple magnets may be disposed in the circumferential direction and fixed with resin or the like.

As described above, the motor 20 in the present embodiment includes the rotor 25 disposed radially outward of the stator 24. Then, the rotor 25 rotates around the stator 24. That is, the motor 20 is an outer-rotor motor.

The impeller 30 is attached to the outside of the rotor cover 251. The impeller 30 is fixed to the rotor cover 251 by bonding, for example. This structure allows the impeller 30 to rotate along with rotation of the rotor 25. The fixing between the impeller 30 and the rotor cover 251 is not limited to bonding, and thus the impeller 30 and the rotor cover 251 are fixed by a fixing method such as press-fitting, welding, or adhesion.

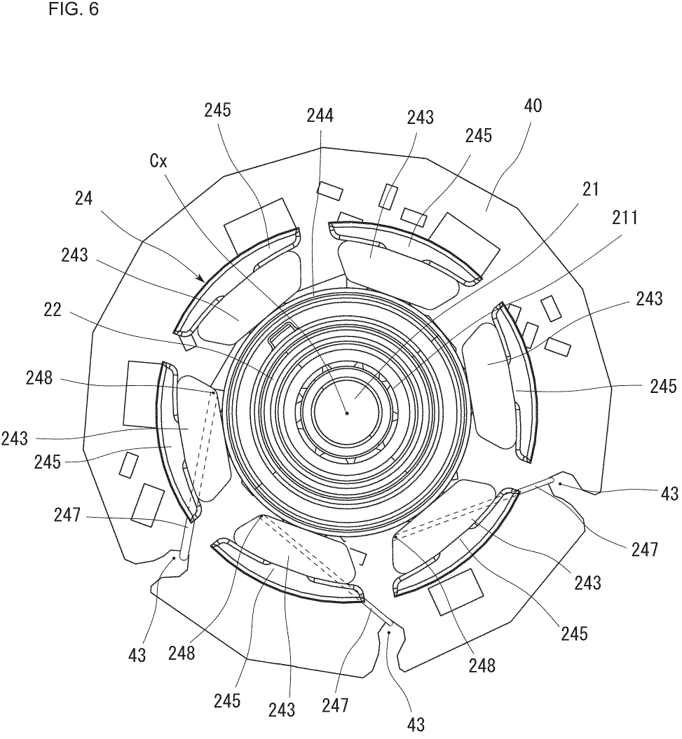

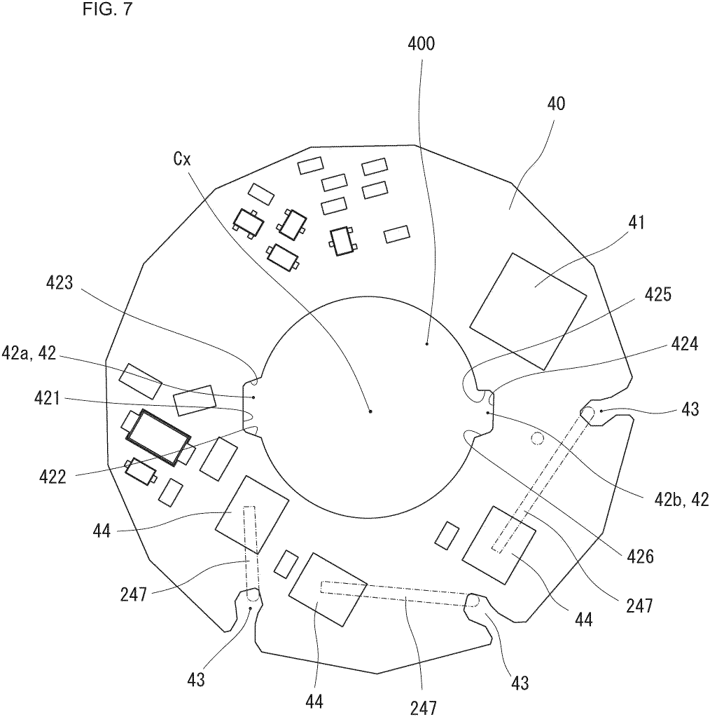

FIG. 6 is a plan view of the circuit board 40 and the stator 24. FIG. 7 is a bottom view of the circuit board 40. FIG. 7 illustrates the circuit board 40 in which conductive wires 247 are each indicated by a one-dot chain line. The circuit board 40 has an annular shape. The circuit board 40 has a surface to which an electronic component 41 is attached to form a control circuit configured to supply power to the coils 243.

The circuit board 40 is provided at its center with a through-hole 400 penetrating in the axial direction. The bearing housing 22 passes through the through-hole 400. As illustrated in FIG. 4 and the like, the circuit board 40 is disposed below the stator 24 and held by the insulator 242 of the stator 24. That is, the circuit board 40 is disposed on one side in the axial direction from the stator core 241. The circuit board 40 is then disposed inside the casing 23. That is, the motor 20 further includes the circuit board 40 disposed inside the casing 23.

The circuit board 40 includes a recess 42 that is recessed radially outward from an edge of the through-hole 400. That is, the circuit board 40 includes the through-hole 400 formed at its central part when viewed from the axial direction, and multiple recesses 42 recessed radially outward from the edge of the through-hole 400.

Snap-fit parts 50 provided on the insulator 242 are accommodated in the respective recesses 42. When the snap-fit parts 50 are fitted into the respective recesses 42, the circuit board 40 is held by the stator 24. Details of the recesses 42 and the snap-fit parts 50 will be described later.

The circuit board 40 has an outer peripheral surface provided with cut-outs 43 recessed radially inward. The different conducting wires 247 are disposed in the respective cut-outs 43, and a leading end of each of the conducting wires 247 is wired on a lower surface side of the circuit board 40. The leading end of each of the conductive wires 247 is electrically connected to corresponding one of lands 44 disposed on a bottom surface of the circuit board 40 (see FIG. 7). That is, the circuit board 40 is electrically connected to the coils 243. The conductive wires 247 are wired from an upper surface side to the lower surface side of the circuit board 40 through the respective cut-outs 43, and are electrically connected to respective circuits (lands 44) on the lower surface side of the circuit board 40. The conductive wires 247 are electrically connected to the respective lands 44 by soldering, for example. However, the connection between the conductive wires 247 and the respective lands 44 is not limited to soldering, and bonding using a conductive adhesive, screwing, or the like may be available.

The circuit board 40 provided with the cut-outs 43 enables the conductive wires 247 to be wired to the lower surface of the circuit board 40 through the corresponding cut-outs 43. This structure facilitates wiring of the conductive wires 247 to the lower surface of the circuit board 40 as compared with a case where holes for passing the respective conductive wires 247 are provided in the circuit board 40 instead of the cut-outs 43. For example, after the circuit board 40 is attached below the stator 24, the conducting wires 247 are routed to the lower surface of the circuit board 40. At this time, the conductive wires 247 are wired in the corresponding cut-outs 43 in which a radially outer edge of the circuit board 40 is opened, so that the stator 24 is less likely to be an obstacle, and thus facilitating the wiring of the conductive wires 247.

The stator 24 includes lead-out parts 248 where the corresponding conductive wires are led out from the respective coils 243. The lead-out parts 248 are provided at three respective positions on the stator 24. The different conducting wires 247 are drawn from the respective lead-out parts 248.

As illustrated in FIG. 6, when the circuit board 40 is attached to the stator 24, the cut-outs 43 and the lead-out parts 248 are shifted in the circumferential direction. This structure enables each of the conductive wires 247 to be wired along a tangential direction of the core back 244 of the stator core 241. As a result, interference between the conductive wires 247 and a member such as the casing 23 is suppressed, and disconnection of the conductive wires 247 is suppressed.

The lead wire 45 is connected to the circuit board 40 (see FIG. 4). That is, the motor 20 further includes the lead wire 45 to be connected to a circuit board. The lead wire 45 connects a power supply device disposed outside the motor 20, or outside the blower A, to the circuit board 40.

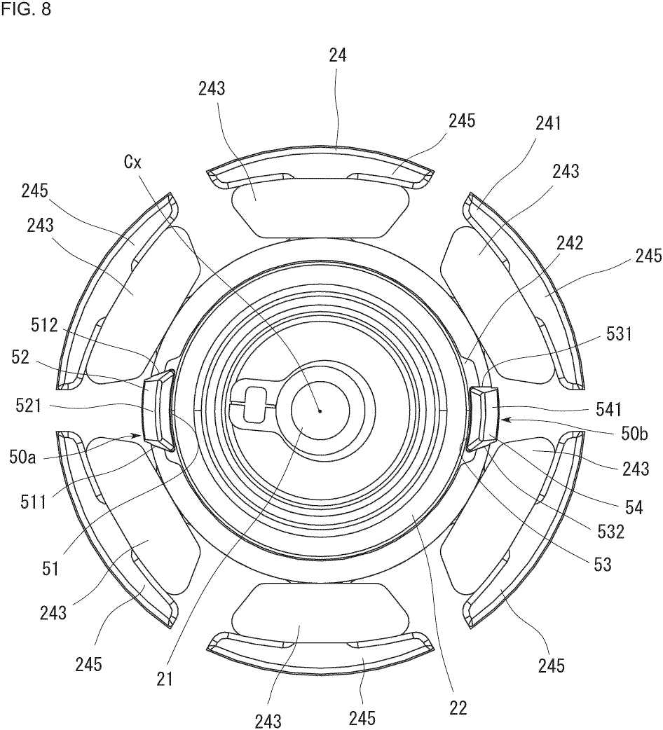

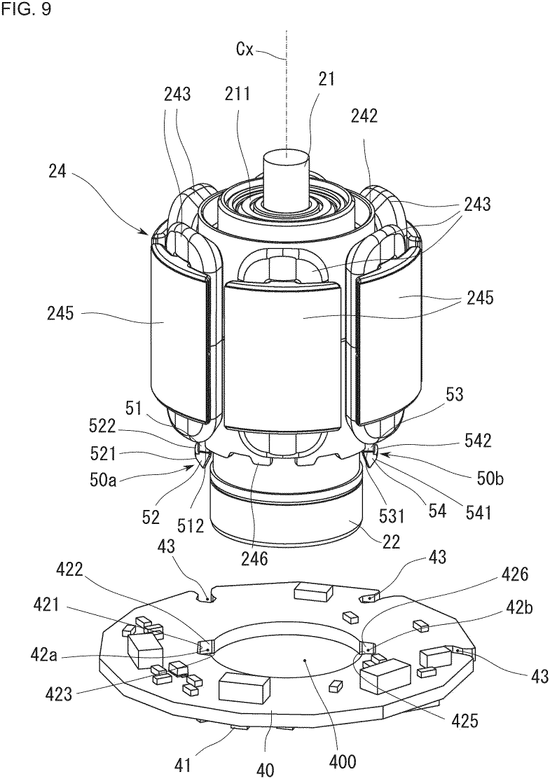

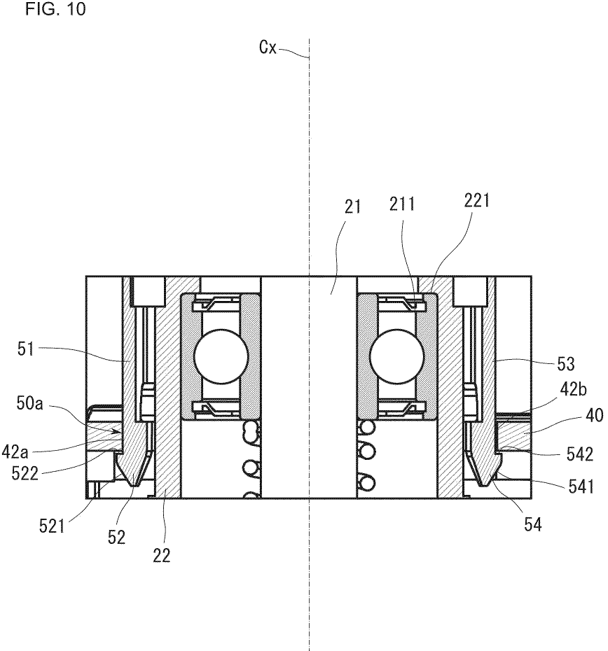

FIG. 8 is a bottom view of the stator 24. FIG. 9 is an exploded perspective view of the stator 24 and the circuit board 40. FIG. 10 is an enlarged sectional view of the snap-fit parts 50. As illustrated in FIGS. 8 and 9, the insulator 242 includes the two snap-fit parts 50. The circuit board 40 includes the two recesses 42. The snap-fit parts 50 are accommodated in the respective recesses 42 formed along the through-hole 400 of the circuit board 40. That is, the insulator 242 includes the snap-fit parts 50 that extend toward the circuit board 40 in the axial direction and fit in the respective recesses 42 of the circuit board 40. The insulator 242 includes the two snap-fit parts 50, and the circuit board 40 includes the two recesses 42.

The circuit board 40 includes the two recesses 42 different in shape. That is, the circuit board 40 includes at least one recess 42 different in shape from another recess 42 as viewed from the axial direction.

The two recesses 42 may be described in the following description such that one of the recesses 42 is referred to as a first recess 42a (e.g., see FIGS. 7 and 9), and the other of the recesses 42 is referred to as a second recess 42b (e.g., see FIGS. 7 and 9) as necessary. Additionally, the two snap-fit parts 50 may be described such that one of the snap-fit parts 50 to be fitted in the first recess 42a is referred to as a first snap-fit part 50a and the other of the snap-fit parts 50 to be fitted in in the second recess 42b is referred to as a second snap-fit part 50b as necessary.

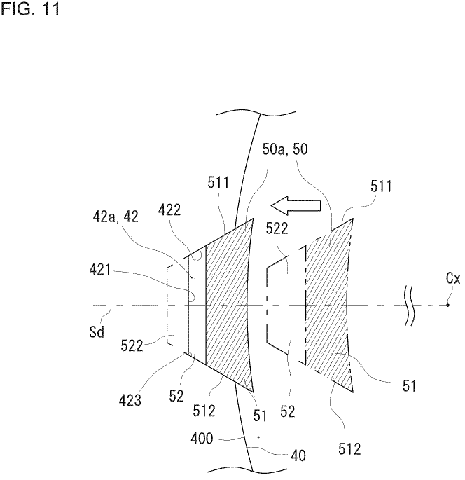

FIG. 11 is an enlarged sectional view of the first recess 42a and the first snap-fit part 50a. FIG. 11 illustrates a line passing through the center (center axis Cx) of the through-hole 400 and extending in the radial direction, the line being defined as a reference line Sd.

As illustrated in FIG. 11, the first recess 42a has a bottom surface 421, and a first inner surface 422 and a second inner surface 423 facing each other in the circumferential direction. That is, the recesses 42a and 42b respectively have a pair of the first inner surface 422 and the second inner surface 423 facing each other in the circumferential direction, and a pair of a third inner surface 425 and a fourth inner surface 426 facing each other in the circumferential direction. The bottom surface 421 faces the center of the through-hole 400 in the radial direction. The first inner surface 422 and the second inner surface 423 are connected to respective opposite ends of the bottom surface 421 in the circumferential direction. The first inner surface 422 and the second inner surface 423 face each other in the circumferential direction.

The first recess 42a has a circumferential interval between the first inner surface 422 and the second inner surface 423, the circumferential interval decreasing radially outward. That is, the circumferential interval between the first inner surface 422 and the second inner surface 423 decreases toward one side in the radial direction. Then, the first inner surface 422 and the second inner surface 423 approach each other radially outward. More specifically, the first inner surface 422 and the second inner surface 423 are inclined with respect to the reference line Sd and are line-symmetric across the reference line Sd when viewed from the axial direction. That is, the first inner surface 422 and the second inner surface 423 of the at least one recess 42a are disposed line-symmetrically across the reference line Sd. The first inner surface 422 and the second inner surface 423 may not be line-symmetric.

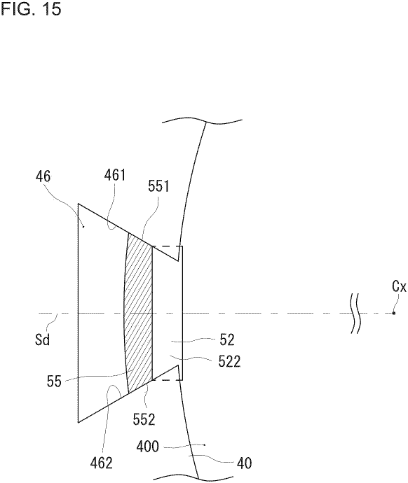

Although the first recess 42a has a circumferential width between the first inner surface 422 and the second inner surface 423, the circumferential width decreasing radially outward, the first recess 42a is not limited thereto. As details are described later, the first inner surface 422 and the second inner surface 423 may have a shape in which a circumferential width decreases radially inward (see FIG. 15), for example.

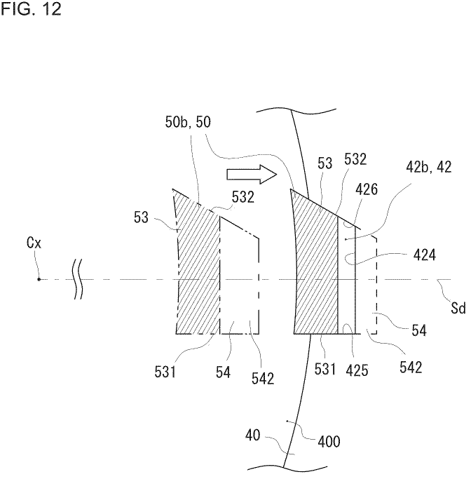

FIG. 12 is an enlarged sectional view of the second recess 42b and the second snap-fit part 50b. As in FIG. 11, FIG. 12 illustrates a line passing through the center (center axis Cx) of the through-hole 400 and extending in the radial direction, the line being defined as the reference line Sd.

As illustrated in FIG. 12, the second recess 42b has a bottom surface 424, and a third inner surface 425 and a fourth inner surface 426 facing each other in the circumferential direction. The bottom surface 424 faces the center of the through-hole 400 in the radial direction. The third inner surface 425 and the fourth inner surface 426 are connected to respective opposite ends of the bottom surface 424 in the circumferential direction. The third inner surface 425 and the fourth inner surface 426 face each other in the circumferential direction.

The second recess 42b has a circumferential interval between the third inner surface 425 and the fourth inner surface 426, the circumferential interval decreasing radially outward. That is, the circumferential interval between the third inner surface 425 and the fourth inner surface 426 decreases toward one side in the radial direction. The third inner surface 425 extends parallel to the reference line Sd. That is, the one inner surface 425 of the at least one recess 42b extends parallel to the reference line Sd that passes through the center (center axis Cx) of the through-hole and extends in the radial direction. Here, the term, “parallel”, includes not only a completely parallel state but also an inclination of several degrees to several tens of degrees. The inner surface 426 approaches the inner surface 425 radially outward.

As illustrated in FIGS. 9 and 11, for example, the first snap-fit part 50a includes an elastic support part 51 and a claw part 52. The elastic support part 51 extends downward along the center axis Cx from a lower end of the insulator tubular part 246. The elastic support part 51 is elastically bendable and deformable.

The elastic support part 51 has a first outer surface 511 and a second outer surface 512 that are disposed at respective opposite ends in the circumferential direction. That is, the snap-fit part 50a has outer surfaces (the first outer surface 511 and the second outer surface 512) disposed at the respective opposite ends in the circumferential direction. The first outer surface 511 and the second outer surface 512 face respective opposite sides in the circumferential direction. A circumferential width between the first outer surface 511 and the second outer surface 512 decreases radially outward. Then, the first outer surface 511 and the second outer surface 512 approach each other radially outward. The first outer surface 511 and the second outer surface 512 are line-symmetric across a line (the reference line Sd in FIG. 11) passing through the center of the elastic support part 51 in the circumferential direction.

The claw part 52 protrudes radially outward from a lower end part of the elastic support part 51. The claw part 52 has an inclined surface 521 and a contact surface 522. The inclined surface 521 inclines upward in a radially outward direction. The contact surface 522 is orthogonal to the center axis Cx and is connected to an upper end of the inclined surface 521.

As illustrated in FIGS. 10 and 11, the first snap-fit part 50a is fitted in the first recess 42a. The first snap-fit part 50a is inserted into the first recess 42a from above. Then, the inclined surface 521 comes into contact with the bottom surface 421 of the first recess 42a. When the first snap-fit part 50a is further moved downward, the inclined surface 521 is pushed by the bottom surface 421 to elastically deform the elastic support part 51 radially inward. As a result, the claw part 52 of the first snap-fit part 50a passes through the first recess 42a.

When the claw part 52 is moved downward below the lower surface of the circuit board 40, the elastic support part 51 returns to its original shape. The contact surface 522 of the claw part 52 then comes into contact with the lower surface of the circuit board 40. At this time, a lower surface of the insulator tubular part 246 comes into contact with the upper surface of the circuit board 40.

When the claw part 52 passes through the first recess 42a, the first outer surface 511 of the elastic support part 51 comes into contact with the first inner surface 422 of the first recess 42a, and then the second outer surface 512 comes into contact with the second inner surface 423. The first snap-fit part 50a is radially separated from the bottom surface 421 of the first recess 42a (see FIG. 11). That is, at least one of the outer surfaces (the first outer surface 511 and the second outer surface 512) is in contact with at least one of the inner surfaces (the first inner surface 411 and the second inner surface 412) of the first recess 42a.

When viewed from the axial direction, the snap-fit part 50 may be configured to be in point contact with at least one of the first inner surface 411 and the second inner surface 412. Even in such a configuration, the snap-fit part 50 is positioned before coming into contact with the bottom surface 421. As a result, even when the recess 42a and the snap-fit part 50 vary in shape, the circuit board 40 can be positioned.

As illustrated in FIGS. 9 and 12, for example, the second snap-fit part 50b includes an elastic support part 53 and a claw part 54. The elastic support part 53 extends downward along the center axis Cx from the lower end of the insulator tubular part 246. The elastic support part 53 is elastically bendable and deformable.

The elastic support part 53 has a third outer surface 531 and a fourth outer surface 532 that are disposed at respective opposite ends in the circumferential direction. That is, the snap-fit part 50b has outer surfaces (the third outer surface 531 and the fourth outer surface 532) disposed at the respective opposite ends in the circumferential direction. The third outer surface 531 and the fourth outer surface 532 face respective opposite sides in the circumferential direction. A circumferential width between the third outer surface 531 and the fourth outer surface 532 decreases radially outward. The third outer surface 531 extends along a line (reference line Sd in FIG. 12) passing through the center of the elastic support part 53 in the circumferential direction. Then, the fourth outer surface 532 approaches the third outer surface 531 radially outward.

The claw part 54 is similar in structure to the claw part 52. The claw part 54 has an inclined surface 541 and a contact surface 542 that correspond to the inclined surface 521 and the contact surface 522 of the claw part 52, respectively. Thus, details of the claw part 54 will not be described.

As illustrated in FIGS. 10 and 12, the second snap-fit part 50b is fitted in the second recess 42b. The second snap-fit part 50b is inserted into the second recess 42b from above. Then, the inclined surface 541 comes into contact with the bottom surface 424 of the second recess 42b. When the second snap-fit part 50b is further moved downward, the inclined surface 541 is pushed by the bottom surface 424 to elastically deform the elastic support part 53 radially inward. As a result, the claw part 54 of the second snap-fit part 50b passes through the second recess 42b.

When the claw part 54 is moved downward below the lower surface of the circuit board 40, the elastic support part 53 returns to its original shape. The contact surface 542 of the claw part 54 then comes into contact with the lower surface of the circuit board 40. At this time, a lower surface of the insulator tubular part 246 comes into contact with the upper surface of the circuit board 40.

When the claw part 54 passes through the second recess 42b, the third outer surface 531 of the elastic support part 53 comes into contact with the third inner surface 425 of the second recess 42b, and then the fourth outer surface 532 comes into contact with the fourth inner surface 426. That is, at least one of the outer surfaces (the third outer surface 531 and the fourth outer surface 532) is in contact with at least one of the inner surfaces (the third inner surface 431 and the fourth inner surface 432) of the second recess 42b. As a result, the second snap-fit part 50b and the second recess 42b are positioned in the circumferential direction. The second snap-fit part 50b is radially separated from the bottom surface 424 of the second recess 42b.

When the two snap-fit parts 50 are fitted in the corresponding recesses 42 as described above, the circuit board 40 is attached to the stator 24. More specifically, the lower surface of the insulator tubular part 246 comes into contact with the upper surface of the circuit board 40. Then, the contact surface 522 of the claw part 52 of the first snap-fit part 50a and the contact surface 542 of the claw part 54 of the second snap-fit part 50b come into contact with the lower surface of the circuit board 40. As a result, the circuit board 40 is held by the insulator tubular part 246 and the snap-fit parts 50.

The first outer surface 511 and the second outer surface 512 of the elastic support part 51 of the first snap-fit part 50a come into contact with the first inner surface 422 and the second inner surface 423 of the first recess 42a, respectively. As a result, the first recess 42a is held against the first snap-fit part 50a in the circumferential direction. The first outer surface 511 and the second outer surface 512, being inclined in the radial direction, come into contact with the first inner surface 422 and the second inner surface 423, also being inclined in the radial direction, respectively, thereby holding the circuit board 40. Thus, even when the first snap-fit part 50a varies in radial thickness, the first recess 42a varies in radial length, and the first inner surface 422 and the second inner surface 423 vary in circumferential position, the circuit board 40 can be accurately positioned in the circumferential direction. Additionally, the first inner surface 422 and the second inner surface 423 of the first recess 42a, and the first outer surface 511 and the second outer surface 512 of the first snap-fit part 50a, are formed in shape with line symmetry, so that the circuit board 40 can be held with the same strength in the circumferential direction. Thus, when the first snap-fit part 50a is fixed, a contact force between the first inner surface 422 and the first outer surface 511 is substantially uniform with a contact force between the second inner surface 423 and second outer surface 512. As a result, positioning accuracy of the circuit board 40 in the circumferential direction can be enhanced.

The third outer surface 531 and the fourth outer surface 532 of the elastic support part 53 of the second snap-fit part 50b come into contact with the third inner surface 425 and the fourth inner surface 426 of the second recess 42b, respectively. As a result, the second recess 42b is held against the second snap-fit part 50b in the circumferential direction. The fourth outer surface 532 inclined in the radial direction comes into contact with the fourth inner surface 426 also inclined in the radial direction, thereby holding the circuit board 40. Thus, even when the second snap-fit part 50b varies in radial thickness, the second recess 42b varies in radial length, and the third inner surface 425 and the fourth inner surface 426 vary in circumferential position, the circuit board 40 can be accurately positioned. Additionally, the third outer surface 531 is configured to be in contact with the third inner surface 425 of the second recess 42b, so that movement of the circuit board 40 in the circumferential direction can be effectively restricted.

The circuit board 40 is held at two different positions in the circumferential direction, and thus is restricted in movement in the circumferential direction. This structure enables the snap-fit parts 50 to position the circuit board 40 in the circumferential direction with respect to the insulator 242. Thus, a member and a recess for positioning can be eliminated.

The above structure allows the first outer surface 511 and the second outer surface 512 of the first snap-fit part 50a to be in contact with the first inner surface 422 and the second inner surface 423 of the first recess 42a, respectively, in the circumferential direction, and allows the third outer surface 531 and the fourth outer surface 532 of the second snap-fit part 50b to be in contact with the third inner surface 425 and the fourth inner surface 426 of the second recess 42b, respectively, in the circumferential direction. This structure enables the two snap-fit parts 50a and 50b, and the two recesses 42a and 42b, to accurately position the circuit board 40 in the circumferential direction. As a result, the snap-fit parts 50 and the recesses 42 can be reduced in number. Reducing the number of recesses enables increasing an area of a part provided with a wiring pattern by reducing a region where the recesses are formed in the circuit board 40, so that a degree of freedom of the wiring pattern can be increased.

Not only the two recesses 42 but also the two snap-fit parts 50 are different is shape, so that the circuit board 40 can be attached to the stator 24 in an accurate orientation and at an accurate position.

The second recess 42b has one inner surface (third inner side surface 425) parallel to the reference line Sd, and thus enabling improvement in accuracy of positioning of the inner surface (third inner side surface 425) of the recess 42b with respect to the outer surface (third outer surface 531) of the snap-fit part 50b in the circumferential direction.

At least one recess 42 has a pair of inner surfaces at a circumferential interval that decreases radially outward. This structure allows the snap-fit part 50 to be disposed inside the recess 42 by bringing the pair of inner surfaces of the recess 42 and the corresponding outer surfaces of the snap-fit part 50 into contact with each other. Thus, the snap-fit part 50 easily enters the recess from radially inward, so that workability is improved.

The wiring part 29 protrudes radially outward from a radially outer edge of the casing 23 when viewed from the axial direction. The wiring part 29 has a wiring space 290 in which the lead wire 45 is disposed. That is, the motor 20 further includes the wiring part 29 having the wiring space 290 in which the lead wire 45 is disposed.

The wiring part 29 includes the first protrusion 291 and the second protrusion 292. As described above, the first protrusion 291 is formed integrally with the casing 23, and the second protrusion 292 is formed integrally with the cover 26. When the first protrusion 291 and the second protrusion 292 vertically stack each other, the wiring space 290 extending in the radial direction is formed inside the wiring part 29.

The wiring part 29 includes the first protrusion 291 extending radially outward from a lower end of the casing 23 and the second protrusion 292 extending radially outward from an outer peripheral surface of the base 261.

More specifically, the first protrusion 291 includes a wiring part top plate 2911 and paired wiring part sidewalls 2912. The wiring part top plate 2911 has a plate shape extending in a direction intersecting the center axis Cx. When viewed from the axial direction, the wiring part top plate 2911 has a rectangular shape extending in the radial direction. The paired wiring part sidewalls 2912 extends axially downward from respective opposite ends of the wiring part top plate 2911 in the circumferential direction. The wiring part top plate 2911 and the paired wiring part sidewalls 2912 are integrally molded. The first protrusion 291 has an axially lower surface that is recessed axially upward and in the radial direction.

The second protrusion 292 has a plate shape extending in a direction intersecting the center axis Cx. The second protrusion 292 has a rectangular shape, and is disposed to face the wiring part top plate 2911 of the first protrusion 291 in the axial direction.

The wiring part 29 is disposed in contact with axially lower ends of the respective paired wiring part sidewalls 2912 of the first protrusion 291. That is, the second protrusion 292 is configured to cover the recess in the lower surface of the first protrusion 291. As a result, the wiring space 290 extending in the radial direction is formed in the wiring part 29. The wiring part top plate 2911 and the second protrusion 292 are in close contact with each other. This structure prevents contamination of foreign materials such as water, dust, and dirt into the wiring space 290 of the wiring part 29. This structure also prevents an inflow of an airflow generated by the impeller 30. The wiring part 29 formed in the casing 23 and the base 261 holds the lead wire 45. That is, the lead wire 45 is reliably held by the casing 23 and the base 261. The lead wire 45 reliably held allows a force acting on the lead wire 45 to be applied to the wiring part 29 even when a force of pulling the lead wire 45 acts. Thus, a force acting on a connection part between the lead wire 45 and the circuit board 40 is reduced. As a result, the lead wire 45 can be prevented from separating from the circuit board 40.

The first frame part 101 and the second frame part 102 form a gap therebetween in the axial direction, and the lead wire placement part 103 in which the lead wire 45 is to be disposed is formed in the gap. The lead wire placement part 103 is connected to the wiring part 29. This structure enables the lead wire 45 to be stably held.

The first protrusion 291 may be in contact with at least the first frame part 101. This structure enables preventing air leakage to the lead wire placement part 103.

The stator 24 and the circuit board 40 are disposed in a space surrounded by the casing 23, the bearing housing 22, and the cover 26. Then, after the stator 24 and the circuit board 40 are each disposed at an accurate position, melted resin is poured into the casing 23. The resin is then cured to form the resin part 60. That is, the resin part 60 is configured to cover the stator 24 in the space surrounded by the bearing housing 22, the casing 23, and the cover 26.

That is, the motor 20 in the present embodiment includes the stator 24 and the circuit board 40 that are accommodated in the casing 23 and sealed by the resin part 60. The motor 20 has the configuration described above.

The motor 20 includes the bearing housing 22 that has the upper end part held by the casing 23, and the lower end part held by the cover 26. Thus, forces applied to the upper end part and the lower end part of the bearing housing 22 in the axial direction during driving of the motor 20 are balanced, and thus vibration of the motor 20 is suppressed. When the bearing housing 22 is connected to the cover 26, the base 261 and the bearing housing 22 are connected with the bush 262 interposed therebetween. This structure enables suppressing deformation of the bearing housing 22 and the base 261 due to a force acting when the bearing housing 22 is connected to the cover 26.

The impeller 30 includes an impeller hub 31 and the multiple blades 32. Although examples of the impeller 30 include a resin injection molding, the impeller 30 is not limited thereto. Material of the impeller 30 is not limited to resin, and may be metal. The blades 32 may be formed separately from the impeller hub 31 and fixed to the impeller hub 31 by a fixing method such as bonding or welding.

As illustrated in FIGS. 1 and 2, for example, the impeller hub 31 includes a lid part 311 and an impeller tubular part 312. The lid part 311 has a disk shape expanding in the radial direction. The impeller tubular part 312 has a tubular shape extending axially downward from a radially outer edge of the lid part 311.

The impeller tubular part 312 has an inner peripheral surface to which the rotor 25 is fixed. More specifically, the impeller 30 is fixed to the rotor 25 by bonding an outer peripheral surface of the rotor tubular part 253 of the rotor 25 to the inner peripheral surface of the impeller tubular part 312. Although bonding is used for fixing the impeller 30 to the rotor 25, the fixing is not limited thereto. For example, a fixing method such as press fitting, adhesion, or screwing may be used.

The multiple blades 32 are disposed on an outer surface of the impeller hub 31 in the circumferential direction. In the present embodiment, the blades 32 are disposed at equal intervals in the circumferential direction. The impeller 30 of the blower A of the present embodiment includes the blades 32 and the impeller hub 31 that are integrally molded with resin, for example. The blades 32 each have an upper part and a lower part, the upper part being disposed forward of the lower part in a rotation direction Rd (see FIG. 1).

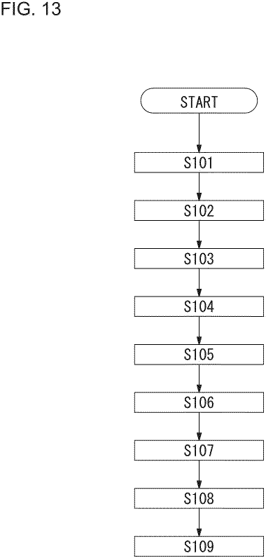

Here, a manufacturing process of the blower A including the motor 20 will be described with reference to the drawings. FIG. 13 is a flowchart illustrating the manufacturing process of the blower A. As illustrated in FIG. 13, first, an upper end part of the bearing housing 22 is press-fitted into the bearing housing attachment boss 233 of the lid part 232 of the casing 23 (step of attaching bearing housing: step S101). That is, step S101 of attaching the bearing housing is performed to attach the bearing housing 22 to the casing 23. As a result, the bearing housing 22 is attached to the casing 23.

The bearing housing 22 is provided with the bearings 211 that is preliminarily attached, and the shaft 21 that is rotatably disposed with the bearings 211. The bearing housing attachment boss 233 penetrates in the axial direction, so that the shaft 21 attached to the bearing housing 22 has an upper end protruding upward from an upper end of the casing 23.

The bearing housing 22 and the bearing housing attachment boss 233 are in close contact with each other. This structure enables preventing leakage of resin from between the bearing housing 22 and the bearing housing attachment boss 233 when the resin is injected in step S104 of injecting resin described later.

Although the bearings 211 and the shaft 21 are preliminarily attached to the bearing housing 22 in the present embodiment, the present invention is not limited thereto. For example, the bearing 211 and the shaft 21 may be attached at an appropriate timing after the bearing housing 22 is attached to the bearing housing attachment boss 233. Then, the bearings 211 and the shaft 21 are attached to the bearing housing 22 and the bearings 211, respectively, by press-fitting. Thus, the bearing housing 22 is preferably attached to the bearing housing attachment boss 233 in a state where the bearings 211 and the shaft 21 are preliminarily attached to the bearing housing 22.

Next, the circuit board 40 is disposed on the stator 24 (step of attaching circuit board: S102). In step S102 of attaching a circuit board, the snap-fit parts 50 of the stator 24 are inserted into the through-hole 400 of the circuit board 40. Then, the snap-fit parts 50 are fitted into the corresponding recesses 42. As a result, the circuit board 40 is positioned in the circumferential direction with respect to the stator 24.

Then, the lower end of the insulator tubular part 246 of the insulator 242 comes into contact with the upper surface of the circuit board 40, and the claw parts 52 and 54 of the snap-fit parts 50 come into contact with the lower surface of the circuit board 40. As a result, the circuit board 40 is held. After that, a conductive wire 247 at the end of the coil 243 is drawn to the lower surface side of the circuit board 40 through a cut-out 43. Then, the conductive wire 247 is electrically connected to the land 44 on the lower surface of the circuit board 40 (see FIG. 7).

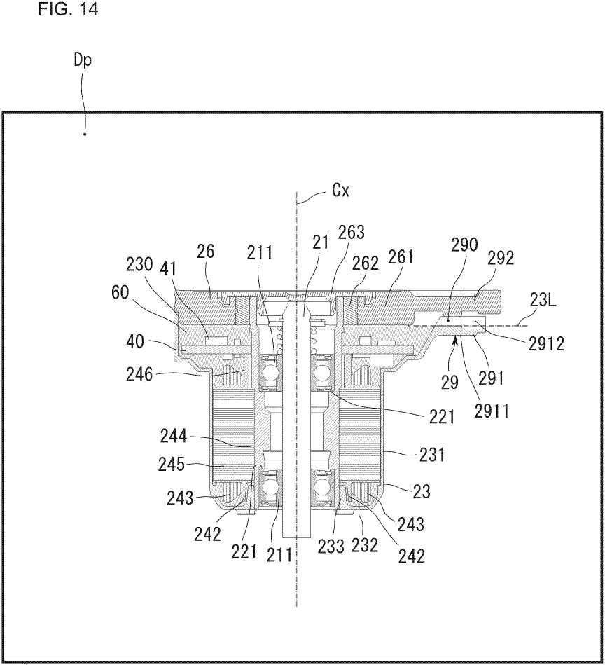

Next, the stator 24 provided with the circuit board 40 attached is accommodated inside the casing 23. FIG. 14 is a sectional view of the casing 23 with the stator 24 and the circuit board 40 accommodated, the casing 23 being vertically inverted. As illustrated in FIG. 14, an inner peripheral surface of the core back 244 of the stator core 241 of the stator 24 is press-fitted onto and fixed to the outer peripheral surface of the bearing housing 22 (step of attaching stator: step S103). That is, the step of attaching a stator (step S103) is performed to attach the stator 24 to at least one of the casing 23 and the bearing housing 22. After the step of disposing a circuit board (step S102), the step of attaching a stator (step S103) is performed.

Although the inner peripheral surface of the core back 244 of the stator 24 is fixed in contact with the outer peripheral surface of the bearing housing 22 in the motor 20 of the present embodiment, the motor 20 is not limited thereto. The teeth 245 of the stator 24 each have an outer edge in the radial direction that may be fixed in contact with the inner peripheral surface of the tubular part 231 of the casing 23. Both the inner peripheral surface of the core back 244 and the outer edge of each of the teeth 245 may be fixed in contact with the corresponding surfaces.

The lead wire 45 is attached to the circuit board 40. When the circuit board 40 is accommodated in the casing 23, the lead wire 45 is disposed along the radial direction in a recess formed in a lower part of the first protrusion 291 protruding radially outward from the casing 23.

The manufacturing process of the present embodiment is performed such that after the circuit board 40 is attached to the stator 24 in step S102 of attaching a circuit board, the stator 24 is attached to the casing 23 in step S103 of attaching a stator. However, the order of attachment is not limited thereto. That is, the circuit board may be attached to the stator 24 in the step of attaching a circuit board after the stator 24 is attached to the casing 23 in the step of attaching a stator. Even when the order of attachment is reversed as described above, forming the cut-out 43 on an outer peripheral surface of the circuit board 40 enables the conductive wire 247 to be routed below the circuit board 40 through the cut-out 43. Thus, the conductive wire 247 can be easily routed, so that workability can be improved.

As described above, the stator 24 and the circuit board 40 are attached inside the casing 23. Next, the casing 23 with the stator 24 and the circuit board 40 accommodated is vertically inverted and held, and then resin is injected from the opening 230 located upward (step of injecting resin: step S104). That is, the step of injecting resin (step S104) is performed such that the resin is injected from the opening 230 at the lower end part of the casing 23 in the axial direction to cover the stator 24 with the resin.

Step S104 of injecting resin is performed to dispose the casing 23 in a decompression region Dp. The decompression region has pressure lower than atmospheric pressure. Available examples of the decompression region include an inner region of a container, in which pressure can be reduced, such as a vacuum chamber. It is assumed that the casing 23, the stator 24, and the circuit board 40 in FIG. 14 are in the decompression region Dp. Then, resin having fluidity is injected into the casing 23 in the decompression region Dp.

When the resin having fluidity is poured into the casing 23, the resin having fluidity is required to be prevented from overflowing from the casing 23. As described above, the tubular part 231 of the casing 23 includes the first protrusion 291 extending radially outward. The first protrusion 291 is open radially outward to form a wiring space.

When the resin having fluidity is poured into the casing 23 from the opening 230, a flow of the resin is stopped before a liquid level of the resin having fluidity reaches an upper end of an inner peripheral surface of the first protrusion 291. As a result, the resin having fluidity can be prevented from overflowing from the casing 23.

As illustrated in FIG. 14, the casing 23 has a limit line 23L determined for resin having fluidity. Step S103 of attaching a stator is performed such that when the stator 24 is attached to the casing 23, the electronic component 41 attached to the circuit board 40 is located inward of the limit line 23L of the casing 23, or is located above the limit line 23L. That is, the step of injecting resin (step S104) is performed such that the resin injected into the casing 23 with the opening 230 facing upward has a liquid level above an upper end of the electronic component 41 mounted on the circuit board 40. This structure allows the circuit board 40 and the electronic component 41 mounted on the circuit board 40 to be sealed together with the stator 24 with the resin part 60, so that the circuit board 40 and the electronic component 41 can be prevented from being in contact with water and foreign materials.

As illustrated in FIG. 14, the limit line 23L is set above the opening 230. That is, the resin part 60 has a lower end (end close to the cover 26) that is located above the opening 230 of the casing 23, or located on a side opposite to the cover 26. This structure enables preventing the resin from overflowing due to expansion and contraction of the resin part 60 during molding. This structure also enables the cover 26 to be reliably attached to the opening 230.

Then, step S104 of injecting resin is performed to inject resin having fluidity until the resin has an upper surface above an upper end of electronic component 41 and below the limit line 23L in the casing 23 turned upside down. That is, the step of injecting resin (step S104) is performed such that the resin is injected with the opening 230 of the casing 23 facing upward, and the injection of the resin is terminated while the upper surface of the resin injected into the casing 23 is below an upper limit (limit line 23L) of a liquid level that can be contained in the casing 23. As a result, the resin can be prevented from overflowing from the casing 23 when the resin is injected into the casing 23. Additionally, when the cover 26 is attached to the casing 23, interference between the resin part 60 and the cover 26 can be prevented, and thus the cover 26 can be accurately attached to the casing 23.

This step allows the resin having fluidity to reliably cover the stator 24, the circuit board 40, and the electronic component 41 attached to the circuit board 40. At this time, the resin having fluidity may be configured to cover the lead wire 45 disposed on the first protrusion 291.

When the resin having fluidity is injected, the cover 26 is not attached over the opening 230. Thus, the resin having fluidity can be injected from the opening 230 larger than a resin injection port provided in the cover 26, for example. As a result, an inflow of the resin having fluidity per unit time can be increased, and thus the injection of the resin can be completed in a short time. Then, partial curing can be prevented from starting in the middle of the injection to prevent uneven curing.

The opening 230 large in area and the injection in the decompression region Dp allow air inside the casing 23 to be easily released during the injection of the resin, so that a defect is less likely to be formed in the resin part 60 formed by curing the resin.

The resin having fluidity is poured in the decompression region Dp. Thus, even when the resin filled in the casing 23 has air bubbles, the air bubbles are compressed when pressure is returned to the atmospheric pressure. As a result, a ratio of air bubbles in the resin part 60 can be reduced, so that deterioration in rigidity of the resin part 60 can be suppressed.

Next, after the casing 23 is filled with the resin, the resin is cured (step S105 of curing resin). That is, the step of curing resin (step S105) is further provided to cure the injected resin immediately after the step of injecting resin (step S104). That is, the casing 23 can be easily moved before the cover 26 is attached to the casing 23. As a result, work efficiency during manufacturing can be enhanced.

Step S105 of curing resin may be performed in the decompression region Dp or may be performed in an atmosphere under the atmospheric pressure. Step S105 of curing resin may be performed such that the resin is heated, or the resin is irradiated with ultraviolet rays. Processing suitable for curing characteristics of resin to be used is performed.

Step S105 of curing resin is performed to cure the resin, thereby completing the resin part 60. At this time, the electronic component 41 is disposed on the lower surface of the circuit board 40, and a lower end of the electronic component 41 is located above a lower end of the resin part 60. When the resin part 60 is completed, the stator 24, the circuit board 40, and the electronic component 41 attached to the circuit board 40 are prevented from being in contact with foreign materials such as water, dust, and dirt. That is, the stator 24, the circuit board 40, and the electronic component 41 can be improved in waterproof performance and dust-proof performance.

Then, the lower end part of the bearing housing 22 is press-fitted into the bush 262 of the cover 26 (step of covering: step S106). That is, the step of covering (step S106) is performed to cover the opening 230 of the casing 23 with the cover 26, and the step of covering (step S106) is performed after the step of injecting resin (step S104).

After the resin is injected from the opening 230 at a lower end of casing 23, the cover 26 is attached to the casing 23. The opening 230 is formed over the entire lower end of the casing 23, and thus allows the resin to be poured easier than an injection port that is formed in the cover 26 and from which the resin is injected. Thus, the resin can be spread to a deep part and a narrow region, so that generation of a void filled with no resin can be suppressed.

The cover 26 is configured to cover the opening 230 at the lower end of casing 23. As a result, the opening 230 of the casing 23 is closed by the cover 26. The cover 26 has a lower end to which the cap part 263 is attached. The cap part 263 is partially inserted into the lower end part of the bearing housing 22 to seal the bearing housing 22. This structure prevents contamination of foreign materials such as water, dust, and dirt into the bearings 211.

When the opening 230 of the casing 23 is covered with the cover 26, the lower part of the first protrusion 291 is covered with the second protrusion 292 integrally molded with the cover 26. This structure allows the wiring space 290 to be formed inside the wiring part 29, the wiring space 290 being provided with the lead wire 45 disposed. The base 261 and the bush 262 of the cover 26 each have an upper end disposed below the lower end of the resin part 60. This structure prevents interference between the cover 26 and the resin part 60.

The cover 26 in the present embodiment is integrally molded with the second frame part 102 of the frame 10 of the blower A. Thus, step S106 of covering is performed such that the casing 23 in which the resin part 60 is formed is disposed inside the second frame part 102, and the lower end part of the bearing housing 22 is press-fitted into the bush 262. That is, the cover 26 includes the bush 262 that is integrally molded with the base 261 in an annular shape radially inward of the base 261, and the lower end part of the bearing housing 22 is press-fitted into the bush 262 in the step of covering (step S106).

The bearing housing 22 made of metal is press-fitted into the bush 262 also made of metal, so that the bearing housing 22 can be firmly fixed to the cover 26. In other words, attachment rigidity of the bearing housing 22 against the cover 26 can be enhanced. This structure enables suppressing inclination and deflection with respect to the center axis Cx of the shaft 21.

Then, an upper end of the shaft 21 protruding from an upper end of the bearing housing 22 is press-fitted into the shaft fixing boss 255 of the rotor 25 to attach the rotor 25 to the shaft 21 (step of attaching a rotor: step S107). As a result, the magnet 252 of the rotor 25 is disposed at a predetermined distance radially outward of the stator 24. The motor 20 is formed according to the above procedure.

Then, the impeller tubular part 312 of the impeller 30 is bonded to the outer peripheral surface of the rotor tubular part 253 of the rotor 25 to fix the impeller 30 to the rotor 25 (step of fixing an impeller: step S108).

After that, the first frame part 101 is stacked on an upper part of the second frame part 102 to fix the first frame part 101 to the second frame part 102, thereby completing the frame 10 (step of assembling frames: step S109). When the first frame part 101 is fixed above the second frame part 102, the lead wire placement part 103 defined by the first frame part 101 and the second frame part 102 is formed in the frame 10. Then, the lead wire 45 is disposed in the lead wire placement part 103. The lead wire 45 is wired to the outside of the blower A via the wiring part 29 and the lead wire placement part 103. This structure enables transmitting a current from a power supply device outside the blower A and a control signal from an external device to the circuit board 40.

Using the method for manufacturing the motor 20 according to the present embodiment enables resin having fluidity to be poured before the cover 26 is attached to the casing 23. As a result, the resin can be quickly poured into the casing 23 before the resin is increased in viscosity by curing. Thus, the resin can be widely spread inside the casing 23, so that a space with no resin disposed can be prevented from being formed.

Additionally, the resin is poured in decompression environment where pressure is reduced to lower than atmospheric pressure, so that air inside the casing 23 is easily discharged to the outside during the pouring of the resin. This also enables a space with no resin disposed to be prevented from being formed. The resin is further poured in the decompression environment and cured in environment under atmospheric pressure, so that pressure of air inside the poured resin decreases lower than the atmospheric pressure. Thus, air bubbles formed inside the resin can be reduced in size. As a result, deterioration in rigidity of the resin part 60 after the resin is cured can be suppressed. Additionally, formation of holes due to air bubbles can be suppressed, so that waterproofness, dustproofness, and explosion-proofness of the motor 20 can be enhanced.

FIG. 15 is a plan view illustrating a recess 46 and a snap-fit part 55 of a modification. As illustrated in FIG. 15, a circumferential width between inner surfaces 461 and 462 of the recess 46 increases radially outward. That is, at least one recess 46 has a pair of inner surfaces 461 and 462 at a circumferential interval that increases radially outward. As with the inner surfaces 461 and 462, a circumferential width between outer surfaces 551 and 552 of the snap-fit part 55 also increases radially outward.

Even when structure as described above is used, a similar effect as in the structure using the recess 42 and the snap-fit part 50 can be obtained.

While the embodiments of the present invention have been described above, the embodiments can be modified in various ways within the scope of the present invention.

The blower of the present invention can be used for a blower or the like used for cooling an electric device or the like.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a shaft that is rotatable about a center axis extending vertically;
a bearing housing in a tubular shape that rotatably supports the shaft with a bearing;
a casing having a tubular shape with a lid, the casing extending axially about the center axis and holding the bearing housing;
a stator disposed radially inside the casing and fixed to at least one of the casing and the bearing housing;
a rotor fixed to the shaft and disposed radially outside the casing;
a cover configured to cover an opening formed in a lower end of the casing; and
a resin part configured to cover the stator in a space surrounded by the bearing housing, the casing, and the cover,
the cover including:
a base in an annular shape; and
a bush disposed radially inside the base and fixed to a lower end part of an outer peripheral surface of the bearing housing.

2. The motor according to claim 1, wherein at least a part of the bush is integrally fixed to the base.

3. The motor according to claim 1, wherein the resin part has a lower end located above the opening of the casing.

4. The motor according to claim 1, further comprising
a circuit board disposed inside the casing,
wherein the circuit board has a lower surface on which an electronic component is disposed, and
the electronic component has a lower end located above a lower end of the resin part.

5. The motor according to claim 4, wherein the stator includes:
a coil; and
a conducting wire drawn out from the coil,
the circuit board has an outer peripheral surface provided with a cut-out recessed radially inward, and
the conducting wire is wired from an upper surface side to a lower surface side of the circuit board through the cut-out, and is electrically connected to a circuit on the lower surface side of the circuit board.

6. The motor according to claim 1, further comprising
a circuit board disposed inside the casing,
wherein the stator includes:
a coil; and
a conducting wire drawn out from the coil,
the circuit board has an outer peripheral surface provided with a cut-out recessed radially inward, and
the conducting wire is wired from an upper surface side to a lower surface side of the circuit board through the cut-out, and is electrically connected to a circuit on the lower surface side of the circuit board.

7. The motor according to claim 5, wherein the cut-out and a drawn part of the conducting wire are displaced from each other in a circumferential direction.

8. The motor according to claim 4, further comprising:
a lead wire connected to the circuit board; and
a wiring part having a wiring space in which the lead wire is disposed,
the wiring part including:
a first protrusion extending radially outward from a lower end of the casing; and
a second protrusion extending radially outward from an outer peripheral surface of the base,
wherein the second protrusion is configured to cover a lower part of the first protrusion.

9. The motor according to claim 1, further comprising:
a circuit board disposed inside the casing;
a lead wire connected to the circuit board; and
a wiring part having a wiring space in which the lead wire is disposed,
the wiring part including:
a first protrusion extending radially outward from a lower end of the casing; and
a second protrusion extending radially outward from an outer peripheral surface of the base,
wherein the second protrusion is configured to cover a lower part of the first protrusion.

10. A blower comprising:
the motor according to claim 1;
an impeller attached to the rotor; and
a frame radially covering an outside of the impeller,
the base being formed integrally with the frame.

11. A blower comprising:
the motor according to claim 9;
an impeller attached to the rotor; and
a frame radially covering an outside of the impeller;
the frame including:
a first frame part;
a second frame part axially coupled to a lower part of the first frame part;
the second frame part and the base being integrally formed; and
a lead wire placement part in which the lead wire is disposed and that is formed in an axial gap between the first frame part and the second frame part,
the lead wire placement part being connected to the wiring part.

12. The blower according to claim 11, wherein the first protrusion is in contact with at least the first frame part.

13. A method for manufacturing a motor,
the motor including:
a shaft rotatable about a center axis extending vertically;
a bearing housing in a tubular shape that rotatably supports the shaft with a bearing;
a casing in a tubular shape with a lid, extending along the center axis and holding the bearing housing;
a stator;
a rotor; and
a cover configured to cover an opening at a lower end of the casing,
the method comprising the steps of:
attaching the bearing housing to the casing;
attaching the stator to at least one of the casing and the bearing housing;
injecting resin from the opening of the casing to cover the stator with the resin; and
covering the opening of the casing with the cover,
the step of covering being performed after the step of injecting.

14. The method for manufacturing a motor according to claim 13, wherein
the cover includes:
a base in an annular shape; and
a bush integrally molded with the base radially inward of the base, and
the bush is press-fitted into a lower end part of an outer peripheral surface of the bearing housing in the step of covering.

15. The method for manufacturing a motor according to claim 13, wherein in the step of injecting, the resin is injected with the opening facing upward of the casing, and injection of the resin is terminated while an upper surface of the resin injected into the casing is below an upper limit of a liquid level that can be contained in the casing.

16. The method for manufacturing a motor according to claim 15, further comprising the step of
disposing a circuit board on the stator,
wherein after the step of disposing, the step of attaching the stator is performed, and
in the step of injecting, the resin injected into the casing with the opening facing upward has an upper surface located above an upper end of an electronic component mounted on the circuit board.

17. The method for manufacturing a motor according to claim 13, further comprising the step of
curing the injected resin immediately after the step of injecting.
